(19) United States
(12) Patent Application Publication
(10) Pub. No.: US 2010/0254756 A1
(43) Pub. Date: Oct. 7, 2010

(54) Bicycle Seat Post Protecting Member

(76) Inventor: Douglas Chiang, Ta-Li City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/417,088

(22) Filed: Apr. 2, 2009

(51) Int. Cl. B62K 19/36

(52) U.S. Cl. 403/373

(57) ABSTRACT

A bicycle seat post protecting member which is utilized for protecting a bicycle seat post clamp from damaging a bicycle seat post is in the form of a ring which has a flexible characteristic. The ring is adapted to be disposed circumferentially between an inner periphery of the bicycle seat post clamp and an outer periphery of the seat tube. The ring defines inner and outer sides, and with the inner side at a proximal end thereof extending outside the outer side at a distal end thereof, and the ring includes an increased region of the inner side extended outside the outer side when the ring is being clamped by the bicycle seat post clamp.

### BACKGROUND OF THE INVENTION

1. Field of the Invention

The present invention relates to a bicycle seat post protecting member and, in particular, to a bicycle seat post protecting member that is utilized for preventing a bicycle seat post clamp damaging a seat post by effectively avoiding the stress concentration.

2. Description of the Related Art

TW Pat. No. M322357 shows a ring that is incorporated in a bicycle seat post clamp. The ring includes first and second ends spaced by a gap. Thus, it has a non-closed cross section. The ring is adapted to be disposed between an inner periphery of the bicycle seat post clamp and an outer periphery of a seat tube. The inner periphery of the bicycle seat post clamp is adapted to be reduced diametrically for holding a seat post which is telescopically received in the seat tube in a fixed relationship. Further, the ring is reduced diametrically and the first and second ends are elastically moved closer to apply pressure on the seat tube. Thus, the seat tube can securely hold the seat post. However, a problem the bicycle seat post clamp generally suffers is that the ring can not distribute the pressure effectively, thus resulting a mark on the seat post or otherwise damaging the seat post at worst.

The present invention is, therefore, intended to obviate or at least alleviate the problems encountered in the prior art.

### SUMMARY OF THE INVENTION

According to the present invention, a bicycle seat post protecting member which is utilized for protecting a bicycle seat post clamp from damaging a bicycle seat post is in the form of a ring which has a flexible characteristic. The ring is adapted to be disposed circumferentially between an inner periphery of the bicycle seat post clamp and an outer periphery of the seat tube. The ring defines inner and outer sides, and with the inner side at a proximal end thereof extending outside the outer side at a distal end thereof, and the ring includes an increased region of the inner side extended outside the outer side when the ring is being clamped by the bicycle seat post clamp.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

The present invention will be described with reference to the accompanying drawings which assist in illustrating the pertinent features thereof, in which:

FIG. 1 is a perspective view of a bicycle seat post protecting member disposed in a bicycle seat post clamp in accordance with a first embodiment of the present invention.

FIG. 2 is an exploded, perspective view of FIG. 1.

FIG. 3 is a perspective view, illustrating the bicycle seat post protecting member is forced to clamp a seat tube and a seat post by the bicycle seat post clamp.

FIG. 4 is a cross-sectional view taken along line 4-4 in FIG. 3.

FIG. 5 is a cross-sectional view taken along line 5-5 in FIG. 3.

FIG. 6 is an extended cross-sectional view of FIG. 5, showing the bicycle seat post clamp in a tightened position.

### DETAILED DESCRIPTION OF THE PREFERRED EMBODIMENT

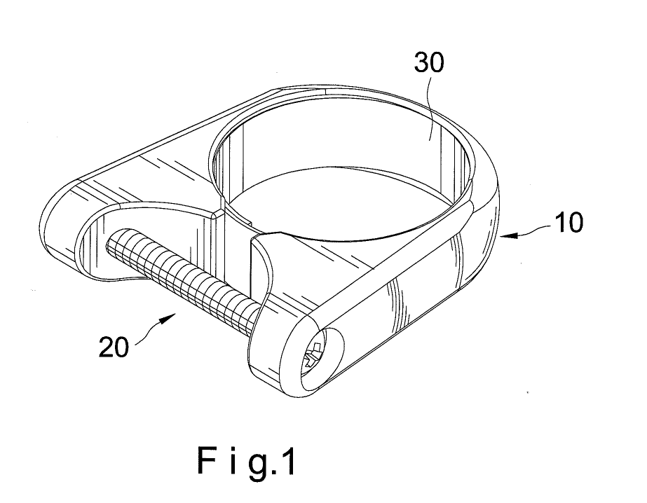

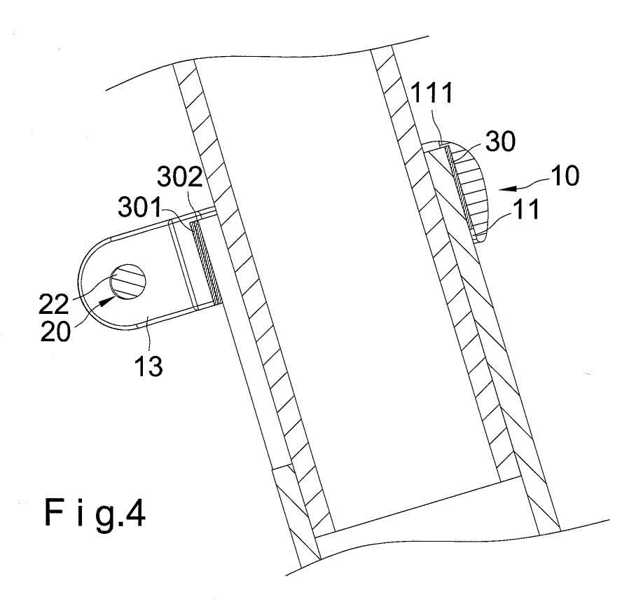

Referring to the FIGS. 1 through 6, a bicycle seat post clamping device includes a bicycle seat post clamp 10 and a flexible ring 30.

The bicycle seat post clamp 10 includes an inner periphery 11 adapted for circumferentially receiving the ring 30. Additionally, the bicycle seat post clamp 10 can be tightened in order to reduce the inner periphery 11 diametreically.

The ring 30 is preferably made of metal as it has a satisfied flexing ability. However, other flexible material can also be used to make the ring 30.

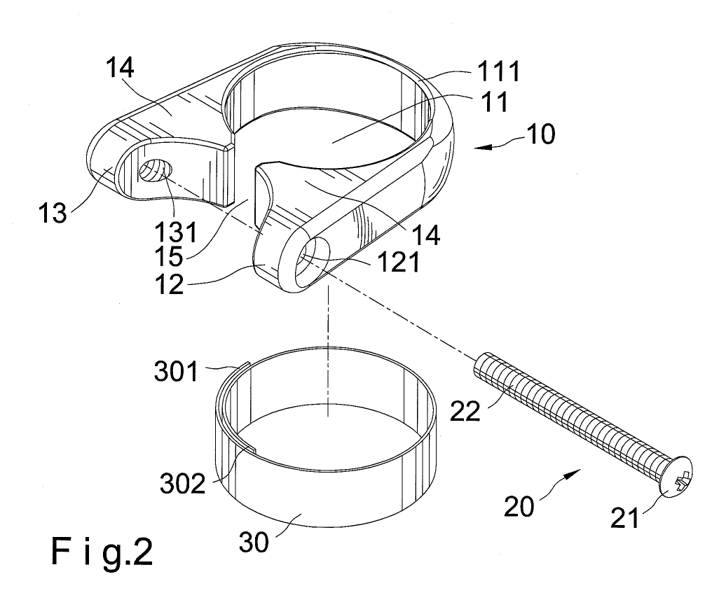

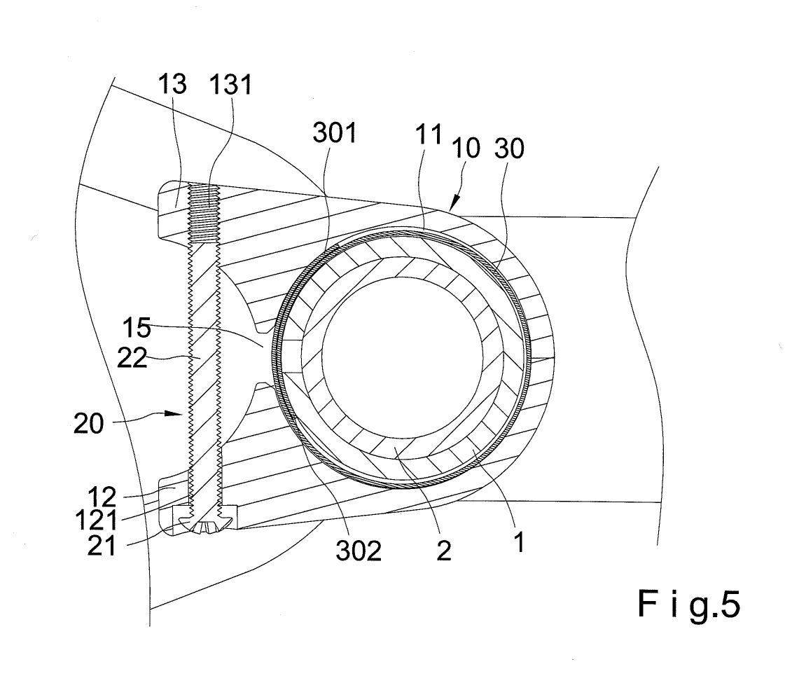

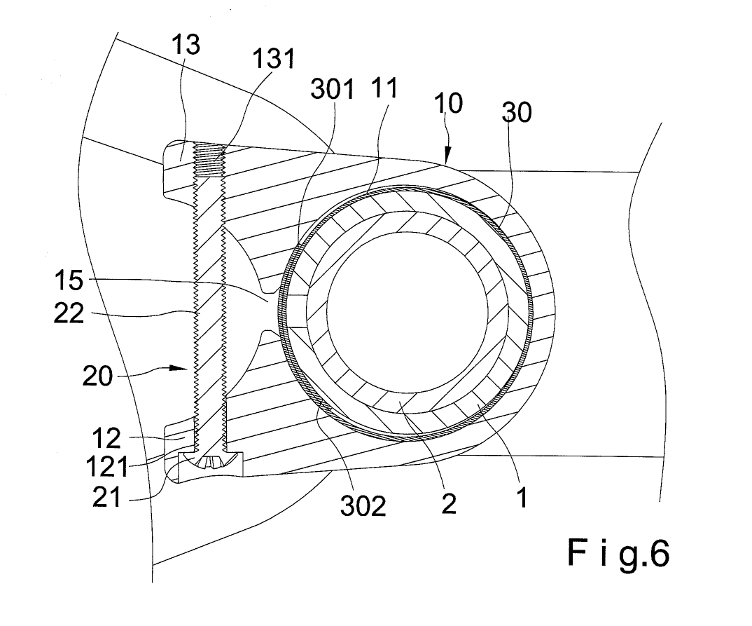

FIG. 2 shows that the ring 30 defines inner and outer sides, and with the inner side at a proximal end 301 thereof extending outside the outer side at a distal end 302 thereof. When the ring 30 is being clamped, the ring 30 include an increased region of the inner side extended outside the outer side (as best shown in FIGS. 5 and 6).

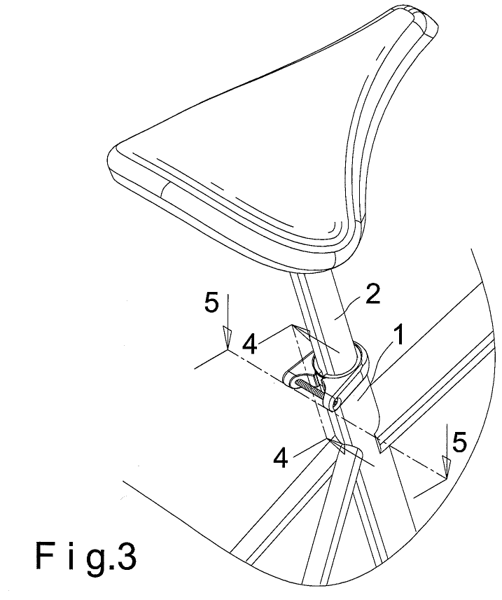

FIG. 3 shows that the ring 30 is disposed between the inner periphery 11 of the bicycle seat post clamp 10 and an outer periphery of a seat tube 1. The ring 30 serves as a bicycle seat post protecting member for preventing the tightened bicycle seat post clamp 10 damaging a bicycle seat post 2 which is telescopically received in the seat tube 1, by distributing clamping pressure evenly and effectively.

In addition, the bicycle seat post clamp 10 includes two protruding ends 12 and 13 opposed to each other and adapted to be moved closer when the bicycle seat post clamp 10 is tightened. In the preferred embodiment, the bicycle seat post clamp 10 may include a fastener 20 which is engagable with the two protruding ends 12 and 13 for tightening the bicycle seat post clamp 10. Further, the two protruding ends 12 and 13 may include first and second holes 121 and 131 extending transversely therethrough respectively for receiving the fastener 20. The fastener 20 includes a head 21 and a shank 22, and the head 21 has a first diametrical length and the shank 22 has a second diametrical length smaller than the first diametrical length. Moreover, the shank 22 may have outer thread formed thereon. The first hole 121 includes an enlarged part for receiving the head 21 and when the head 21 is received by the enlarged part of the first hole 121, the bicycle seat post clamp 10 is prevented from being further moved axially in the tightening direction.

Moreover, the bicycle seat post clamp 10 includes two reinforcing members 14 extending toward each other and an opening 15 between the two reinforcing members 14, and with the opening 15 connecting to and in communication with the periphery 11 of the bicycle seat post clamp 10.

Based on the forgoing, the ring 30 includes an aspect to distribute the clamping pressure applied by the bicycle seat post clamp 10 evenly and effectively. Thus, the ring 30 prevents the bicycle seat post clamp 10 damaging the seat post 2.

While the specific embodiments have been illustrated and described, numerous modifications come to mind without significantly departing from the spirit of invention, and the scope of invention is only limited by the scope of the accompanying claims.

What is claimed is:

1. A bicycle seat post protecting member for protecting a bicycle seat post clamp from damaging a bicycle seat post, with the seat post telescopically received in a seat tube comprising:
a flexible ring adapted to be disposed circumferentially between an inner periphery of the bicycle seat post clamp and an outer periphery of the seat tube, and with the inner periphery being reducible diametrically when the bicycle seat post clamp is being tightened, the ring defining inner and outer sides, and with the inner side at a proximal end thereof extending outside the outer side at a distal end thereof; and
wherein the ring includes an increased region of the inner side extended outside the outer side when the ring is being clamped.

2. The bicycle seat post protecting member as claimed in claim 1 wherein the ring is made of metal.

3. A bicycle seat post clamping device comprising:
a bicycle seat post clamp defining an inner periphery, and with the inner periphery being reducible diametrically when the bicycle seat post clamp is being tightened;
a flexible ring disposed circumferentially in the inner periphery of the bicycle seat post clamp and defining inner and outer sides, with the inner side at a proximal end thereof extending outside the outer side at a distal end thereof; and
wherein the ring includes an increased region of the inner side extended outside the outer side when the ring is being clamped by the bicycle seat post clamp.

4. The bicycle seat post clamping device as claimed in claim 3 wherein the ring is made of metal.

5. The bicycle seat post clamping device as claimed in claim 3 wherein the bicycle seat post clamp includes two protruding ends opposed to each other and adapted to be moved closer when the bicycle seat post clamp is tightened, and a fastener is engagable with the two protruding ends for tightening the bicycle seat post clamp.

6. The bicycle seat post clamping device as claimed in claim 5 wherein the two protruding ends include first and second holes extending transversely therethrough respectively for receiving the fastener.

7. The bicycle seat post clamping device as claimed in claim 6 wherein the fastener includes a head and a shank, and with the head having a first diametrical length and the shank having a second diametrical length smaller than the first diametrical length, and wherein the first hole includes an enlarged part receiving the head.

8. The bicycle seat post clamping device as claimed in claim 3 wherein the bicycle seat post clamp includes two reinforcing members extending toward each other and an opening between the two reinforcing members, and with the opening connecting to and in communication with the periphery of the bicycle seat post clamp.
